(19) United States
(12) Patent Application Publication
(10) Pub. No.: US 2008/0016456 A1
(43) Pub. Date: Jan. 17, 2008

(54) Method and system for providing docked-undocked application tabs

(76) Inventors: Liam Friedland, Redwood City, CA (US); Peer Hilgers, St. Leon-Rot (DE)

Correspondence Address: KENYON & KENYON LLP, 1500 K STREET N.W., WASHINGTON, DC, 20005, US

(21) Appl. No.: 11/485,248

(22) Filed: Jul. 11, 2006

(51) Int. Cl. G06F 9/00

(52) U.S. Cl. 715/771; 715/777; 715/835; 715/840

(57) ABSTRACT

A system and method are provided for providing a graphical user interface environment to a user. A view of a plurality of applications and an active application may be provided to an output device. The view may be selected from a group consisting of a windows view where each of the plurality of applications is displayed in a separate window and a tabs view where each of the plurality of applications is displayed in a tab included in a window. The user may switch between the windows view and the tabs view.

### BACKGROUND

In order to view tasks, transactions and other applications, an enterprise system may include a graphical user interface (GUI). In general, a GUI is a method of interacting with a computer through a metaphor of direct manipulation of graphical images and widgets in addition to text. The GUI may display tasks, transactions and other applications to the user as icons on a computer screen and receive user selection of tasks, transactions and other applications to execute or view through an input device such as a mouse pointer.

One type of GUI is a tabs interface or view that allows multiple panes of information or displays to be contained within a single master window, using tabs to navigate between the panes. Only one pane is displayed to the user at a time.

Another type of GUI is a windows interface or view where a new window is created for each pane of information or display that is displayed to the user. Individual windows are created and handled separately by the operating system's window manage.

Both types of interfaces have their advantages. The tabs view allows many different documents to be held logically under the one window, instead of a large number of small child windows. In addition, using tabs instead of new windows to display content creates a smaller memory footprint and therefore reduces the strain on the operating system. However, a large number of tabs in a tabs interface may clutter up available space for view tabs.

### BRIEF DESCRIPTION OF THE DRAWINGS

FIG. 1 illustrates a screen shot of a launcher application according to an embodiment of the present invention.

FIG. 2 illustrates a screen shot of a tabs view according to an embodiment of the present invention.

FIG. 3 illustrates a screen shot of a windows view according to an embodiment of the present invention.

FIG. 4 illustrates a screen shot according to an embodiment of the present invention.

FIG. 5 illustrates a screen shot according to an embodiment of the present invention.

FIG. 6 illustrates a procedure for providing a graphical user interface according to an embodiment of the present invention.

FIG. 7 illustrates a system for providing a graphical user interface according to an embodiment of the present invention.

### DETAILED DESCRIPTION

In a GUI, a user may prefer a windows view in certain circumstances and a tabs view in others. For example, a user may prefer a tabs view when there are many related applications that need to be displayed. An application may be a pane of information, an application executed on the system, a report displayed to the user, or a task to be completed. Alternatively, a user may prefer a windows view when there are only several applications to be displayed.

In certain GUIs, a user may rapidly switch between separate windows by tapping out a hot-key combination on an input device. For example, this functionality may not be available in a tabs view. Thus, a user may prefer a windows view when rapid switching between separate windows is helpful.

An example embodiment of the present invention may be a procedure for providing a graphical user interface environment, the procedure may include providing a view of a plurality of applications and an active application to an output device, the view selected from a group consisting of a windows view, wherein each of the plurality of applications is displayed in a separate window within the graphical user interface environment and the active application is displayed in an active window, and a tabs view, wherein each of the plurality of applications is displayed in a tab included in a window within the graphical user interface environment and the active application is displayed in a workspace of the window. The procedure may also include switching between the windows view and the tabs view responsive to a user request to switch views. The active application may be selected from the plurality of applications. The graphical user interface environment may include a launcher application for processing a user input. The launcher application may further include a button to receive the user request to switch views, a first level main menu displaying a plurality of first level menu items, and a first level work area. The active application may be changed to a second application selected from the plurality of applications responsive to a user input. The procedure may further include launching a new application into a new window in the windows view or a new tab in the tabs view responsive to a user request to launch the new application. The applications may include an application executed on the processor, a report displayed on the output device or a task to be completed by a user. The tabs view may display a plurality of related applications in a window with multiple tabs.

A second example embodiment of the present invention may be a system for providing a graphical user interface environment, the system may include an input device for receiving user input, an output device for displaying the graphical user interface environment, and a processor for executing the graphical user interface environment responsive to the user input, the processor configured to launch a new application responsive to the user input, provide a view of a plurality of applications and an active application to the output device, the view selected from a group consisting of a windows view, wherein each of the plurality of applications is displayed in a separate window within the graphical user interface environment and the active application is displayed in an active window, and a tabs view, wherein each of the plurality of applications is displayed in a tab included in a window within the graphical user interface environment and the active application is displayed in a workspace of the window, and switch between the windows view and the tabs view responsive to a user request to switch views. The active application may be selected from the plurality of applications. The graphical user interface environment may include a launcher application executed on the processor for receiving the user input. The launcher application may further include a button to receive the user request to switch views, a first level main menu, and a first level work area. The switch may be executed responsive to a user request to change an active application to a second application selected from the plurality of applications. A new application may be launched into a new window in the windows view or a new tab in the tabs view. The tabs view may display a plurality of related applications in a window with multiple tabs. The applications may include an application executed on the processor, a report displayed on the output device or a task to be completed by a user.

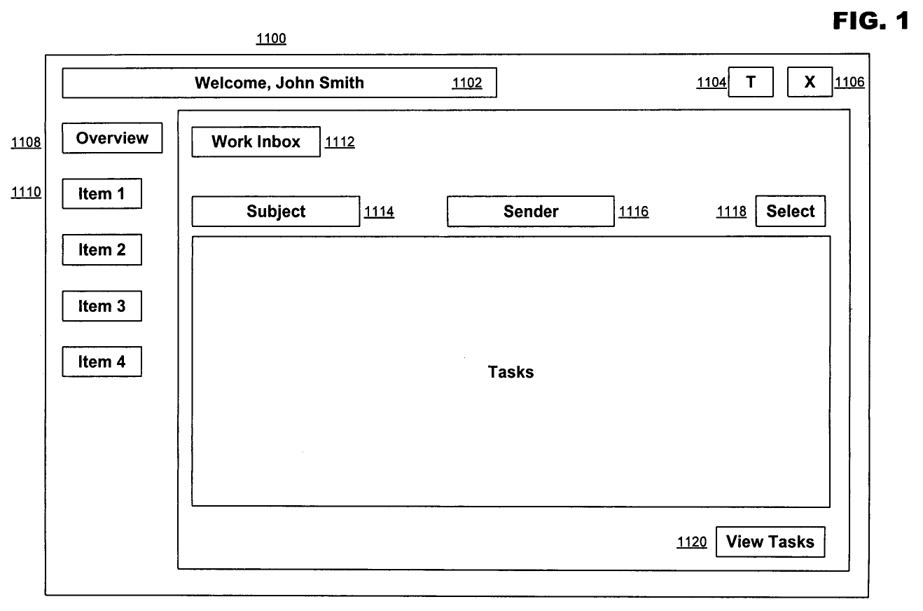

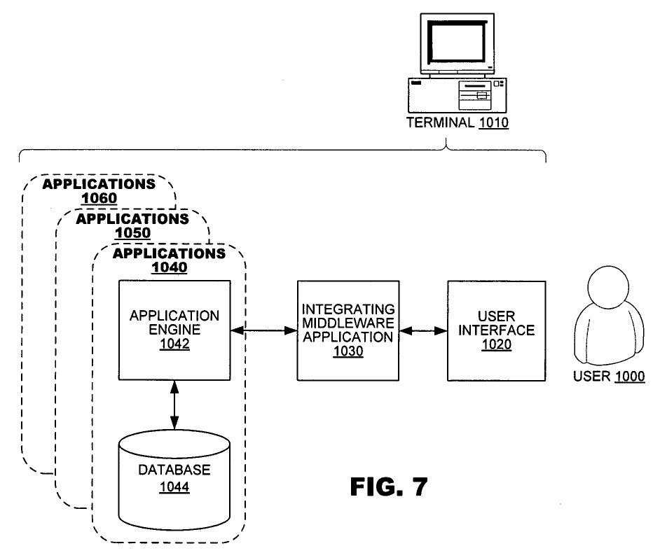

FIG. 1 illustrates a screen shot of a launcher application according to an embodiment of the present invention. The launcher application 1100 may be executed on a system as depicted in FIG. 7 and may be displayed to the user as an object in a GUI. For example, the launcher application may be an application executed in a separate window, an applet, or a widget in the GUI.

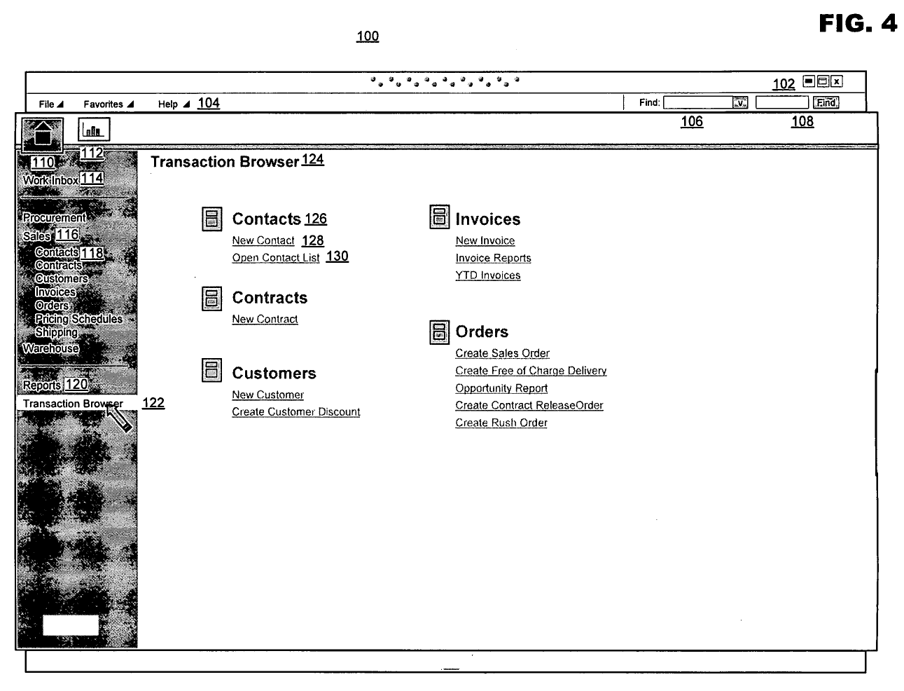

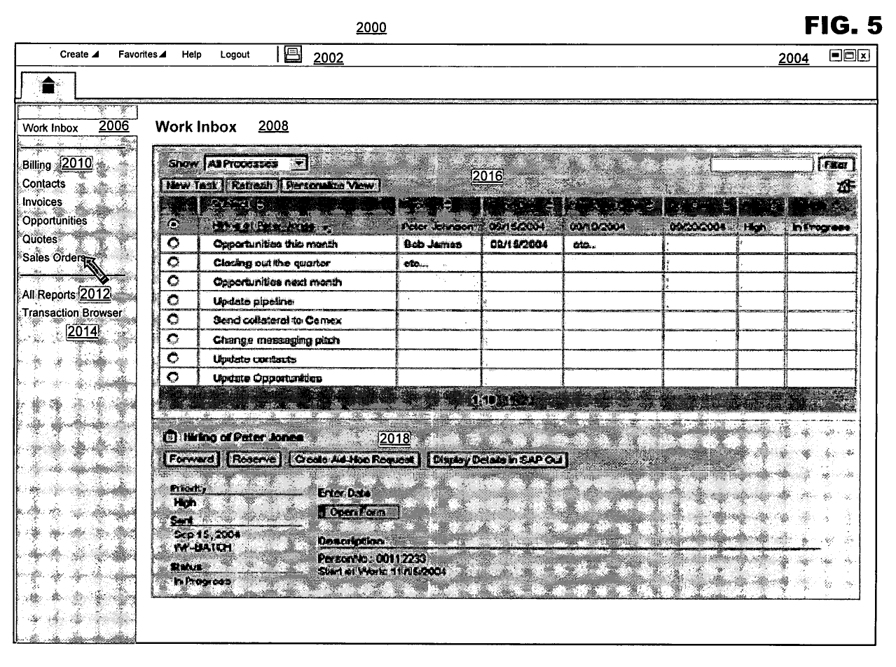

The launcher application 1100 may appear in a separate window in the GUI which provides links to user-accessible applications and a toggle control. The user-accessible applications may include a transaction browser as depicted in FIG. 4 and a work inbox as depicted in FIG. 5. A plurality of applications may be displayed in the GUI in a tabs view or a windows view. The toggle control may be activated by the user to switch between the tabs view and the windows view.

The launcher application 1100 may include a title 1102. For example, the title 1102 may display a current user's username, a welcome message, or any other information useful to the user while using the launcher application.

The launcher application 1100 may include a button 1104 for switching between two views of a GUI, such as a tabs view and a windows view. This allows the user to elect a helpful or preferred view based on user preference. Alternatively, GUI may switch between the tabs view and the windows based on other criteria, such as programmer- or system-defined conditions.

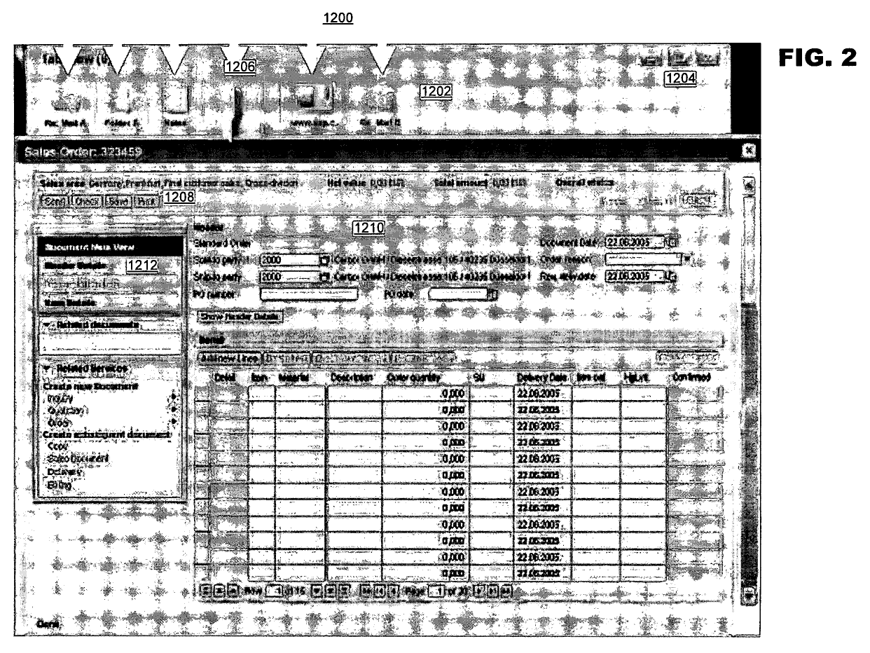

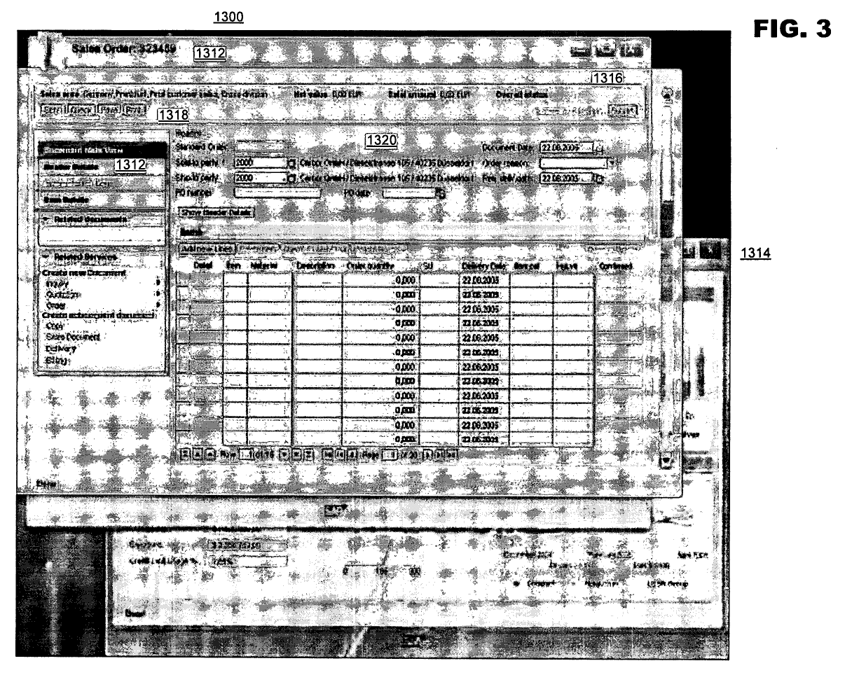

For example, the toggle control may be the button 1104. The button 1104 may receive the user's input indicating a desire to switch the GUI from a tabs view to a windows view. Responsive to the user clicking on button 1104, the GUI may switch between a tabs view as depicted in FIG. 2 and a windows view as depicted in FIG. 3. The button 1104 may also receive the user's input indicating a desire to switch back from a windows view to a tabs view.

In an alternative embodiment, the user may indicate a desire for both a tabs view and a windows view. For example, related applications may be collected in a tabs view, while other applications may be displayed in a windows view. In this embodiment, the GUI may receive the user's desire on how the applications are collected and stored as user preferences. The user preferences may be user-set or application-set. A default set of user preferences may be available.

The launcher application 1100 may include a close button 1106. The close button 1106 may close the launcher application 1100. For example, the user may close the launcher application 1100 before shutting down the system.

The launcher application 1100 may include a first level main menu 1108. The first level main menu 1108 may include a plurality of shortcuts or icons for frequently used applications accessible to the user. The first level main menu 1108 may be different for each user on the system.

For example, the first level main menu 1108 may include a plurality of first level menu items 1110. Each first level main menu item 1110 may be a shortcut or an icon. The user may click on a first level menu item 1110 to access a summary view of the associated application, to be displayed in a first level work area 1112.

The launcher application 1100 may include a first level work area 1112. For example, the first level work area 1112 may include a small display area for a summary view of an application. The first level work area 1112 may include frequently used functionality of the selected application. In FIG. 1, the first level work area 1112 is displaying a summary view of a work inbox. For example, a work inbox may also have a detailed view, as depicted in FIG. 5.

The launcher application 1100 may include column headings 1114, 1116 and 1118. The launcher application 1110 may also have button 1120. For example, the column headings 1114, 1116 and 1118 and the button 1120 may be specific to the application displayed in the first level work area 1112. In FIG. 1, the column headings 1114, 1116 and 1118 depict a subject, a sender and a check box for the work inbox. Clicking on button 1120 may display a selected item to the user.

For example, the work inbox summary depicted in FIG. 1 may be a summary of a full work inbox available on the system. The full work inbox may be as depicted in FIG. 5.

FIG. 2 illustrates a screen shot of a tabs view according to an embodiment of the present invention. The tabs view 1200 may be displayed at the terminal of the system depicted in FIG. 7. For example, the tabs view 1200 may be displayed in a window of the GUI at the terminal of the system. The tabs view 1200 may be configured to display a plurality of applications and includes tab icons 1202. Each tab icon 1202 may be a graphical icon corresponding to an application executed on the system accessible to the user. The user may access different applications in the tabs view 1200 by clicking on the corresponding tabs icon. When a new application is launched by the launcher application, a new tab is created among the tab icons 1202 and the application is displayed in the work area. The tabs view may be switched to a windows view when the user activates the toggle control as depicted on the application launcher in FIG. 1.

The tabs view 1200 may include window controls 1204. The window controls 1204 may allow the user to minimize, maximize or close the tabs view 1200. Other functions relevant to control of the view may also be available, such as resizing or moving the tabs view 1200.

The tabs view 1200 may indicate an active application with a special active tab icon 1206. FIG. 2 indicates the active application is the graphical depiction of an open folder. The tab icon 1202 corresponding to the active application may be so depicted, and the active tab icon 1206 may change when the active application is changed by the user.

The active application may be an application selected by the user to be displayed in the work area 1210. The work area 1210 may display the data and input fields relevant to the active application. The tabs view 1200 may include a work area menu 1208 that includes menu items specific to the active application.

The tabs view 1200 may also include a work area sub menu 1212. The sub menu 1212 may include links to other applications related to the active application.

The work area menu 1208, the work area 1210 and the sub menu 1212 may in combination display all the information and input fields relevant to the active application.

FIG. 3 illustrates a screen shot of a windows view according to an embodiment of the present invention. The windows view 1300 may be displayed at the terminal of the system depicted in FIG. 7. For example, the windows view 1300 may be displayed in a GUI at the terminal of the system. The windows view 1300 may be configured to display a plurality of applications, each application in its own window. A second window 1314 may be displayed in the windows view 1300. The user may access different applications by clicking on the corresponding windows. When a new application is launched by the launcher application, a new window is created and the application is displayed in the new window. The windows view may be switched to a tabs view when the user activates the toggle control as depicted on the application launcher in FIG. 1.

The windows view 1300 may include window controls 1316 on each window. The window controls 1316 may allow the user to minimize, maximize or close the corresponding window. Other functions relevant to control of the view may also be available, such as resizing or moving the corresponding window.

The windows view 1300 may indicate an active application with an active window accessible to the user. The active application may be an application selected by the user and displayed in the work areas 1318, 1312 and 1320 of the corresponding window.

The windows view 1300 may include a title 1312. For example, the title 1312 may display a current user's username, a welcome message, a title of the associated application, or any other information useful to the user.

FIG. 4 illustrates a screen shot according to an embodiment of the present invention. The screen shot depicts a transaction browser 100 in a window of a system displaying all visible transactions organized by categories, where the transactions are visible based on the user's role in a role-based access control system.

The transaction browser 100 may be an application in the system displayed on the GUI separately from the launcher application depicted in FIG. 1. Thus, the transaction browser 100 may be either displayed in a tabs view of FIG. 2 or a windows view of FIG. 3. The toggle control included on the launcher application may allow the user to switch from the tabs view to the windows view and back.

A transaction browser 100 may display all transactions available to a user based on the user's role or roles within a role-based access control system. Transactions are applications that receive data from the user. For example, creating a new sales order, entering contact information of a customer may be transactions.

A report browser may also be available. Reports are representations of data and information made to the user. For example, reports may be charts or tables of recent sales, upcoming deadlines, or other information.

The transaction browser 100 may include window control buttons 102. Window control buttons 102 may include buttons to minimize, restore up/down and close the transaction browser 100.

The transaction browser 100 may include a menu 104. The menu 104 may include menu categories such as file, favorites and help. Each menu category may include one or more menu items.

The transaction browser 100 may include a find text dropdown box 106. The find text dropdown box 106 may include a dropdown button that activates a dropdown text display area. The dropdown text display area displays common search terms or a number of last used search terms.

The transaction browser 100 may include a find text entry box 108. The find text entry box 108 may receive user input of search terms to find in the transaction browser 100. The find text entry box 108 may include a find button which begins a search when clicked. The search may search among transactions and text of the transactions displayed by the transaction browser 100.

The transaction browser 100 may include a home button 110 which returns the user to a home page. The home page may include links to transactions, reports and applications available to the user.

The transaction browser 100 may include a report button 112, which displays a list of reports available for display to the user when clicked. The transaction browser 100 may include other buttons or tabs that display other information.

The transaction browser 100 may include a work inbox link 114, which may display a list of outstanding tasks for the user to complete and other information when clicked. The work inbox may also include messages, announcements, and an aggregation of all information a user needs in his role.

The transaction browser 100 may include one or more categories 116. The transaction browser 100 may include one or more transactions 118. A transaction 118 may be an application to be executed by the user, a task to be completed, or any other application on the system available to the user.

Each transaction 118 may be associated with a category 116. As depicted, contacts transaction 118 is in the sales category 116. Transactions 118 may be sorted into categories 116 based on user roles.

For example, a user who is in sales may have access to a view contacts application and a list of contact information. The view contacts application may be in a contracts category. The user may also have access to a form contract generator application, which creates new contracts based on user inputs. The form contract generator application may be in a contracts category. The user may also have access to a form order creator, which accepts input from the user regarding a sale and transmits it to the finance, manufacturing and shipping departments. The form order creator may be in an order category.

The transaction browser 100 may include a reports browser link 120, which displays a reports browser. The reports browser may be similar to the transaction browser 100 except it provides access to reports. For example, the system may generate reports periodically or in real-time. Reports may also be subject to access control based on the user's role or roles.

The transaction browser 100 may include a transaction browser link 122, which displays a transaction browser frame 124 in a main active area of the window when clicked. The transaction browser frame may display all transactions 128 and 130 visible to the user organized by categories 126.

Clicking on a category 126 may also take the user to a filtered work inbox. Clicking on a transaction 128 or 130 may take the user to a screen displaying the selected transaction.

FIG. 5 illustrates a screen shot according to an embodiment of the present invention. The screen shot may be a view of the user's work inbox 2000 in a window. The work inbox 2000 may be a full work inbox available to the user, a summary of which is displayed on the launcher application as depicted in FIG. 1.

The work inbox 2000 may be an application in the system displayed on the GUI separately, similar to the transaction browser depicted in FIG. 4. Thus, the work inbox 2000 may be either displayed in a tabs view of FIG. 2 or a windows view of FIG. 3. The toggle control included on the launcher application may allow the user to switch from the tabs view to the windows view and back.

The work inbox 2000 may include a menu 2002. The menu 2002 may include menu categories such as create, favorites, help, log out and print. Each menu category may include one or more menu items selectable by the user.

The work inbox 2000 may include window control buttons 2004. Window control buttons 2004 may include buttons to minimize, restore up/down and close the work inbox 2000.

The work inbox 2000 may include a work inbox link 2006. Clicking on the work inbox link 2006 may bring up the work inbox display 2008 in the active work space. The work inbox 2008 may also be set as a user's home page.

The work inbox 2000 may include categories 2010. Clicking on a category 2010 may display transactions associated with the category.

The work inbox 2000 may include a reports browser link 2012.

The work inbox 2000 may include a transaction browser link 2014. Clicking on the transaction browser link may bring up the transaction browser.

The work inbox 2000 may include a work inbox display 2008, where items relevant to the user are displayed. The work inbox 2000 may include a list of items 2016. Each item may be a message, outstanding transaction, incomplete task, or other applications on the system visible to the user and necessary to the user's role.

The work inbox 2000 may include a detailed view 2018 of an item selected in 2016. For example, details such as a send time, a priority level, a status indicator, and a description may be displayed. In addition, action buttons such as reply, display additional details, create form may be available to the user for acting on or completing the item.

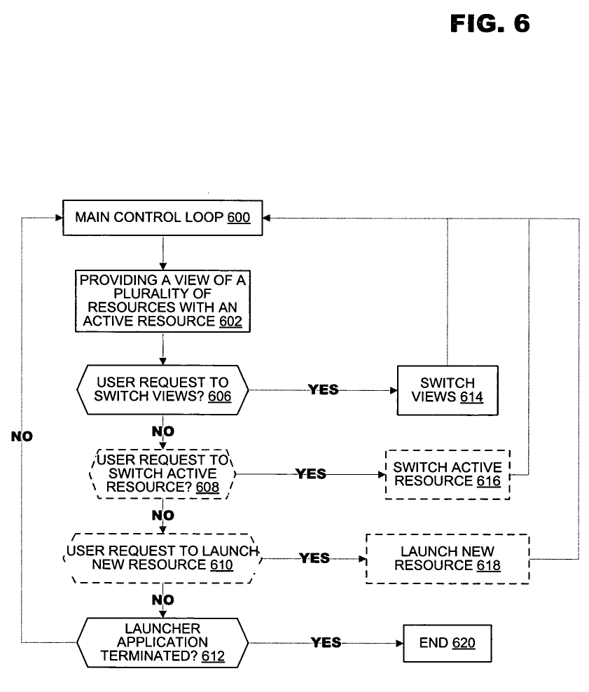

FIG. 6 illustrates a procedure for providing a graphical user interface according to an embodiment of the present invention. For example, the procedure may execute on a system depicted in FIG. 7 interacting with a user. In 600, a main control loop of a launcher application may be executed. The main control loop may be executed on a system repeatedly until the launcher application is terminated by the user in 612, at which point the launcher application will end in 620. Alternatively, the launcher application may be terminated by sources other than the user, such as an operating system error, an automatic expiration associated with the application, or any other appropriate termination condition. The launcher application may be as depicted in FIG. 1.

The system may execute a plurality of applications available to the user. Each application may be an application executed on the system, a report displayed to the user, or a task to be completed.

In 602, the launcher application may provide a view of a plurality of applications with one active application to the user. The view may be a tabs view as depicted in FIG. 2 or a windows view as depicted in FIG. 3. An active application may be displayed to the user.

In 606, the user may submit a request to switch views. For example, the user may wish to switch from the tabs view to the windows view, or from the windows view to the tabs view. The user may submit the request via a user interface as depicted in FIG. 7. For example, the user interface may include a launcher application.

In 614, the system may switch views as requested by the user.

In 608, the user may optionally request to switch the active application. For example, the active application may be switched to a second application selected from the plurality of applications also executing on the system. The user may thus switch the active application to any of the plurality of applications.

In 616, the system may switch the active application to the application specified by the user in 608.

In 610, the user may optionally request to launch a new application. The user may select the new application from a list of available applications displayed via the user interface. The user may also specify whether to launch the new application in a windows view or a tabs view.

In 618, the system may launch the new application specified by the user in 610 on the system. If the user specified a windows or tabs view to launch the new application in, the system may launch the new application in the appropriate view.

FIG. 7 illustrates a system for providing a graphical user interface according to an embodiment of the present invention. A terminal 1010 may be available to a user 1000. The terminal 1010 may include an output device such as a display screen and an input device such as a keyboard or a mouse. For example, the terminal 1010 may be a personal or workstation computer, a laptop computer, a tablet computer, a personal digital assistant (PDA) or a wireless device such as a cell phone.

The terminal 1010 may include a processor configured to execute various application programs such as browser programs, word processing programs, spreadsheet programs, enterprise management applications and other applications. For example, the terminal 1010 may execute a user interface 1020. For example, the user interface 1020 may be implemented as a shell program and configured to display a list of visible transactions based on a user role.

The user interface 1020 may be in communication with an integrating middleware application 1030. The middleware application 1030 may interface between the user interface 1020 and applications 1040. Applications 1040 may include an application engine 1042 and a database 1044. More than one application engine may be provided in the system. For example, each application engine may execute a plurality of applications.

The application engine 1042 may execute different applications, such as a calendar software, a contacts management software, a customer data entry form, sales order creation form, or other applications. The database 1044 may include transaction data relevant to the applications offered on the terminal 1010. Data may include information for each transaction or report available through the applications 1040. Data may also include user data associated with the user 1000. Data may also include business logic defining available actions in applications 1040.

The terminal 1010 may include a plurality of applications. For example, applications 1050 and 1060 may also execute on the terminal 1010. Each of applications 1050 and 1060 may be similar to applications 1040, and include an application engine and a database. The applications 1040-1060, associated engines and databases may form or be part of a “back-end” responsive to a “front-end” component such as user interface 1020. For example, the back-end may include metadata and functionality configured to associate user information, such as a user role and/or identity, with corresponding role-based content to be presented in the user interface. The user interface may collect the user information, for example by way of a logon, and make a call to the back-end for the appropriate role-based content.

While the applications 1040, 1050 and 1060 may share a similar architecture and each possess an application engine and a database, they may possess functionality totally different from each other.

The terminal 1010 may include a network interface configured to communicate with a server. For example, the applications 1040 may be located at the server. In this example embodiment, the middleware application 1030 may communicate with the applications 1040 via the network interface.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A method for providing a graphical user interface environment, comprising:
providing a view of a plurality of applications and an active application to an output device, the view selected from a group consisting of
a windows view, wherein each of the plurality of applications is displayed in an application window within the graphical user interface environment and the active application is displayed in an active window, and
a tabs view, wherein each of the plurality of applications is displayed in a tab included in a window within the graphical user interface environment and the active application is displayed in a workspace of the window; and
switching between the windows view and the tabs view responsive to a user request to switch views.

2. A method of claim 1, wherein the active application is selected from the plurality of applications.

3. A method of claim 1, wherein the graphical user interface environment includes a launcher application for processing a user input.

4. A method of claim 3, wherein the launcher application further includes
a button to receive the user request to switch views,
a first level main menu displaying a plurality of first level menu items, and
a first level work area.

5. A method of claim 1, wherein the active application is changed to a second application selected from the plurality of applications responsive to a user input.

6. A method of claim 1, further comprising:
launching a new application into a new application window in the windows view or a new tab in the tabs view responsive to a user request to launch the new application.

7. A method of claim 1, wherein the applications include an application executed in the graphical user interface, a report displayed to the user or a task to be completed by a user.

8. A method of claim 1, wherein the tabs view displays a plurality of related applications in a window with multiple tabs.

9. A system for providing a graphical user interface environment, comprising:
a plurality of applications and an active application displayed in one of
a windows view, wherein each of the plurality of applications is displayed in an application window within the graphical user interface environment and the active application is displayed in an active window, and
a tabs view, wherein each of the plurality of applications is displayed in a tab included in a window within the graphical user interface environment and the active application is displayed in a workspace of the window; and
a toggle control that toggles between the windows view and the tabs view responsive to a user input.

10. A system of claim 9, wherein the active application is selected from the plurality of applications.

11. A system of claim 9, wherein the graphical user interface environment includes a launcher application for receiving the user input.

12. A system of claim 11, wherein the launcher application further includes
a first level main menu, and
a first level work area.

13. A system of claim 9, wherein the active application is changed to a second application selected from the plurality of applications responsive to a user input.

14. A system of claim 9, wherein a new application is launched into a new application window in the windows view or a new tab in the tabs view.

15. A system of claim 9, wherein the tabs view displays a plurality of related applications in a window with multiple tabs.

16. A system of claim 9, wherein the applications include an application executed on the system, a displayed report or a task to be completed by a user.
